(19) United States
(12) Patent Application Publication
(10) Pub. No.: US 2026/0200197 A1
(43) Pub. Date: Jul. 16, 2026

(54) PRINTING ASSEMBLY, PRINTING METHOD AND MATERIAL WEB

(71) Applicant: BHS Corrugated Maschinen- und Anlagenbau GmbH, Weiherhammer (DE)

(72) Inventors: Helmut Kraus, Wackersdorf (DE); Karl Ruhland, Pfreimd (DE)

(21) Appl. No.: 19/135,180

(22) PCT Filed: Dec. 8, 2022
(86) PCT No.: PCT/EP2022/085008

§ 371 Date: Jun. 3, 2025

(51) Int. Cl. B31B 50/88; B31B 50/00; B31B 50/18; B41F 13/60; B41F 33/00

(52) U.S. Cl. CPC B31B 50/88; B31B 50/006; B31B 50/18; B41F 13/60; B41F 33/0081

(57) ABSTRACT

A printing assembly (15) for printing imprints (16) onto a corrugated cardboard web (23), which is laminated on both sides, and/or at least one material web (3, 4, 10, 12) for forming the corrugated cardboard web (23), which is laminated on both sides, is capable of receiving printing data relating to the printing and of adjusting at least one position of at least one of the imprints (16) in a longitudinal direction of the web.

The invention relates to a printing assembly and to a system with at least one such printing assembly. The invention further relates to a printing method. The invention also relates to a material web.

Corrugated cardboard plants and methods for producing corrugated cardboard are generally known from the prior art through public prior use. The disadvantage is that the prior art repeatedly produces corrugated cardboard sheets whose imprint is cut off by a cross-cut or incorrectly placed relative to a lateral edge. This creates corrugated cardboard waste, which impairs the economic efficiency of the corrugated cardboard plant and is contrary to environmental considerations.

The invention is therefore based on the object of providing a printing assembly which overcomes the disadvantages of the prior art. In particular, a printing assembly that allows the production of particularly high-quality corrugated cardboard sheets with the lowest possible corrugated cardboard waste is to be created. A corresponding system and method as well as a corresponding material web are also to be provided.

This object is achieved according to the invention by the features specified in independent claims 1, 4, 14, and 15. Advantageously, at least one position of at least one imprint, in particular of each imprint, can be spatially displaced with respect to the corresponding corrugated cardboard sheet or the corresponding web in the transport direction of the corrugated cardboard and/or counter to the transport direction of the corrugated cardboard or the longitudinal direction of the web. For example, for this purpose, at least one imprint can be printed earlier or later by the printing assembly onto the transported corrugated cardboard web, which is laminated on both sides, and/or at least one material web for forming the corrugated cardboard web, which is laminated on both sides. The material web is, for example, a corrugated cardboard web, which is laminated on one side, and/or at least one material web for forming the same.

The printing data originate, for example, directly or indirectly, from an actuation assembly, such as a control, in particular a corrugated cardboard plant actuation assembly, a production actuation assembly, or the like. They relate, for example, to positions (longitudinal positions/lateral positions), size and/or resolution of the imprints or what is to be printed. The printing assembly is capable of receiving the printing data and of printing the imprints accordingly onto the web to be printed.

The corrugated cardboard web, which is laminated on both sides, is, for example, three-layer, five-layer, or seven-layer.

It is advantageous if each corrugated cardboard part-web has imprints, preferably a plurality of imprints. The imprints may be identical or different. For example, the finished corrugated cardboard is printed on one or both sides.

Each corrugated cardboard sheet has two opposite lateral edges, which preferably run parallel to one another and are produced by cross-cutting a (partial) corrugated cardboard web, which is laminated on both sides. The lateral edges preferably extend perpendicularly to the transport direction of the corrugated cardboard. Each corrugated cardboard sheet also has two opposite longitudinal edges, which advantageously run parallel to one another and extend in the transport direction of the corrugated cardboard. The lateral edges and longitudinal edges of each corrugated cardboard sheet preferably run perpendicular to one another. It is expedient if the corrugated cardboard sheets have an identical length in the transport direction of the corrugated cardboard. They are preferably rectangular.

The at least one device for producing at least one corrugated cardboard web, which is laminated on one side, advantageously comprises a respective corrugating unit for forming a corrugated web and preferably a gluing unit for gluing the corresponding corrugated web and preferably a pressing unit for pressing a particular cover web against the assigned corrugated web provided with glue.

The device for producing a corrugated cardboard web, which is laminated on both sides, is advantageously designed as a heating and pressing device. It preferably comprises a heating table with heating elements and a pressing belt, which is guided around guide rollers and forms a pressing gap with the heating table. The at least one glued corrugated cardboard web, which is laminated on one side, and the laminating web are guided through the pressing gap, where they are pressed together and glued together.

The printing assembly is advantageously designed as a digital printing assembly, in particular an inkjet printing assembly. It is expedient if the imprints are formed by ink, paint, or the like, in particular by ejecting the same. Preferably, the imprints each comprise at least one number, one letter, one photo, one graphic, or the like. They advantageously cover, at least in regions, a printing side of the web to be printed.

The longitudinal cutting device is preferably designed as a longitudinal cutting/creasing device for longitudinal cutting and creasing of the corrugated cardboard web, which is laminated on both sides. It is preferably capable of cutting the corrugated cardboard web, which is laminated on both sides, at a distance from the longitudinal edges thereof.

It can produce longitudinal edges of the corrugated cardboard sheets. It is expedient if the longitudinal cutting device has at least one longitudinal cutting unit and one counter unit assigned thereto.

It is advantageous if the cross-cutting device is capable of producing cross-cuts that extend over the entire width of the corrugated cardboard part-webs and thus form corresponding lateral edges, which run perpendicular to the transport direction of the corrugated cardboard, on the corrugated cardboard sheets. The cross-cutting device advantageously has at least one cross-cutting roller with at least one radially outwardly extending cross-cutting blade for completely transversely severing the corrugated cardboard part-webs being guided through the cross-cutting device. The cross-cutting device preferably comprises two cross-cutting rollers, which are arranged in pairs and each of which can be rotationally driven about a rotational axis. The rotational axes preferably run parallel to one another. Advantageously, there is a roller gap between the cross-cutting rollers, through which roller gap the corrugated cardboard part-webs are guided. It is expedient for each cross-cutting roller to have or carry at least one cross-cutting blade. The cross-cutting blades of the cross-cutting rollers work together to sever the particular corrugated cardboard part-web so that corrugated cardboard sheets are present downstream of the cross-cutting device.

The at least one cross-cutting blade preferably extends axially to a longitudinal or rotational axis of the associated cross-cutting roller and in the circumferential direction around the longitudinal or rotational axis of the associated cross-cutting roller. It preferably runs in a spiral or curved shape around the longitudinal or rotational axis. For example, it is arranged spirally on a lateral surface of the corresponding cross-cutting roller in such a way that an inclined position of the rotational axis with regard to the transport direction of the corrugated cardboard is compensated. The particular corrugated cardboard part-web can be severed by means of the at least one corresponding cross-cutting blade in a straight line perpendicular to the transport direction of the corrugated cardboard. The inclined position of the rotational axis/axes allows progressive cutting of the particular corrugated cardboard part-web as the cross-cutting roller(s) rotate. Corrugated cardboard sheets with a specified length can be produced in this way.

The corrugated cardboard plant actuation assembly is advantageously designed as a control and/or regulating assembly. It is preferably of an electrical or electronic nature. It is expedient if the corrugated cardboard plant actuation assembly is at least temporarily in direct or indirect signal connection with the at least one printing assembly and/or cross-cutting device.

The signal connections specified here may, for example, be wireless or wired. Information or data can thus preferably be transferred unidirectionally or bidirectionally.

The terms “arranged upstream”, “arranged downstream”, “upstream”, “downstream”, or the like used here relate in particular to the transport direction of the particular web.

Further advantageous embodiments of the invention are specified in the dependent claims.

The printing assembly according to dependent claim 2 is capable of printing imprints next to one another, i.e., in rows. Preferably, it is also capable of printing imprints one after the other, i.e., in columns. The printing assembly is also preferably capable of at least one of the imprints arranged in a row or next to one another being arranged appropriately offset relative to the other imprints arranged in this row.

The printing assembly is thus capable of adjusting at least one (longitudinal) position of at least one imprint on the web accordingly. Conventionally, the imprints arranged next to one another are not offset relative to one another, i.e., are aligned with one another or exactly in one row or line. According to the invention, the imprints are preferably arranged in such a way that they are arranged in a stepped or stair-like manner. They are advantageously arranged in descending or ascending order in the particular row. For example, a particular offset between imprints arranged adjacently in the row is identical. The imprints arranged next to one another in the width direction of the corrugated cardboard part-webs are preferably identical.

The printing assembly according to dependent claim 3 is, for example, capable of printing depending on a cross-cutting device or can be actuated, in particular controlled, accordingly. In this way, it is preferably possible to produce corrugated cardboard sheets whose at least one imprint is precisely aligned with at least one corresponding cross-cut or lateral edge thereof. It has been found that, when corrugated cardboard part-webs, which are laminated on both sides, are cross-cut to form a corresponding (partial) lateral edge or corrugated cardboard sheet, a cutting offset occurs across the width or transverse direction of the corrugated cardboard part-webs, which is particularly noticeable due to their printing and repeatedly leads to corrugated cardboard waste. When cross-cutting the corrugated cardboard part-webs arranged next to one another, this cutting offset is due in particular to the fact that the webs are pulled in the transport direction of the corrugated cardboard and their web tension thus changes successively as they are cross-cut consecutively. According to the invention, it has been recognized that such an offset can be easily and functionally reliably compensated by printing depending on the cross-cutting device or the cross-cutting process. The material web is printed accordingly.

It is expedient if the printing assembly prints in such a way that at least one imprint is aligned with at least one cross-cut of the corresponding corrugated cardboard sheet.

The printing assembly is preferably actuated, in particular controlled, accordingly for the alignment of the imprint. It is expedient if the printing assembly has at least one printing assembly actuation unit, in particular a printing assembly control unit, or is in signal connection with such a unit, at least temporarily, directly or indirectly.

Preferably, the at least one cross-cut extends perpendicularly and/or along the at least one adjacent/associated imprint.

The finished corrugated cardboard is visually extremely appealing. This prevents the at least one cross-cut from intersecting the at least one adjacent imprint and thus the corresponding at least one imprint being incomplete or disturbed.

The cross-cut detection assembly according to dependent claim 5 advantageously comprises at least one cross-cut detection unit, such as a cross-cut detection camera, cross-cut detection sensor, and/or cross-cut detection laser, in particular a cross-cut detection line laser. It is expedient if the cross-cut detection assembly operates contactlessly or optically. For example, it is capable, by itself, of detecting the produced cross-cuts or lateral edges of the corrugated cardboard sheets, in particular their position or course, in particular in relation to the corresponding corrugated cardboard sheet. For example, the at least one cross-cut detection unit can be displaced adjacently to the corrugated cardboard sheets in a width direction of said corrugated cardboard sheets. For example, it forms a traversing system. Alternatively, the cross-cut detection assembly has, for example, a plurality of cross-cut detection units, in particular arranged next to one another, wherein each corrugated cardboard part-web is preferably assigned at least one cross-cut detection unit.

The cross-cut position evaluation unit according to dependent claim 6 is in particular of an electrical or electronic nature. It is at least temporarily in direct or indirect signal connection with the cross-cut detection assembly. The cross-cut position evaluation unit is in particular capable of evaluating the positions of the cross-cuts or lateral edges of the corrugated cardboard sheets, in particular with respect to the corresponding corrugated cardboard sheet.

Preferably, the cross-cut position evaluation unit is part of the corrugated cardboard plant actuation assembly. Alternatively, they are designed to be separate from one another, for example.

The embodiment according to dependent claim 7 is particularly cost-effective and functionally reliable. The cross-cut detection assembly is capable of detecting both the produced cross-cuts and cross-cutting marks that trigger a cross-cutting process.

It is expedient if a reproduction of corrugated cardboard is carried out when the amount of corrugated cardboard waste exceeds a limit value. Such a system is particularly reliable. The limit value can preferably be specified.

The cross-cut detection assembly and the at least one printing assembly according to dependent claim 8 are preferably at least temporarily in direct or indirect signal connection with one another.

The experience database according to dependent claims 9 or 10 again leads to an extremely efficient and environmentally friendly corrugated cardboard plant. It is expedient if the experience database is at least temporarily, in particular directly or indirectly, in signal connection with the corrugated cardboard plant actuation assembly, the cross-cutting device, the cross-cut detection assembly, and/or a production control. It can be updated, preferably at any time, early and/or in good time, in particular when the corrugated cardboard plant is in operation. It is advantageous if at least one detected or recognized actual value and/or one finding can be stored in the experience database. Advantageously, at least one finding can be used for later orders or order combinations. It is expedient if a comparison with the experience database is carried out before starting a new order. If at least one corresponding value already exists in the experience database, it is advantageously transmitted as a start parameter to the at least one printing assembly.

The embodiment according to dependent claim 11 results in particularly high-quality corrugated cardboard. Waste is avoidable.

The at least one printing assembly according to dependent claim 12 is capable of adapting to the cross-cutting device, in particular individually. For this purpose, it is actuated, in particular controlled, accordingly. For this purpose, the cross-cutting device and the at least one printing assembly are at least temporarily in direct or indirect signal connection with one another. For example, the at least one printing assembly can be adapted to the type and/or design of the cross-cutting unit, such as the at least one cross-cutting roller or the at least one cross-cutting blade, and/or orientation/arrangement of the at least one cross-cutting unit, or the like. The at least one property is, for example, an individual property of the cross-cutting device.

According to dependent claim 13, the at least one printing assembly is, for example, part of the corrugated cardboard plant. In particular, the at least one printing assembly is integrated in the corrugated cardboard plant. Alternatively, the at least one printing assembly and the corrugated cardboard plant are arranged, for example, at a distance from one another, such as spatially separated from one another. For example, they are arranged in different hall areas, districts, cities, companies, locations, or the like. For example, printing and corrugated cardboard production are carried out separately in terms of space and time.

The dependent claims and statements regarding them also relate to preferred developments of independent claim 14.

Two preferred embodiments of the invention are described below by way of example with reference to the accompanying drawings.

### IN THE FIGURES

FIG. 1 is a simplified view of a system according to the invention with a printing assembly integrated in a corrugated cardboard plant,

FIG. 2 is a block diagram illustrating primarily the operation of the printing assembly and cross-cutting device of the system shown in FIG. 1,

FIG. 3 is a plan view of a material web according to the invention with imprints arranged offset to one another,

FIG. 4 is a simplified view of a system according to the invention according to a second embodiment, in which the printing assembly is arranged upstream of the corrugated cardboard plant, and

FIG. 5 is a block diagram illustrating primarily the operation of the printing assembly and cross-cutting device of the system shown in FIG. 4

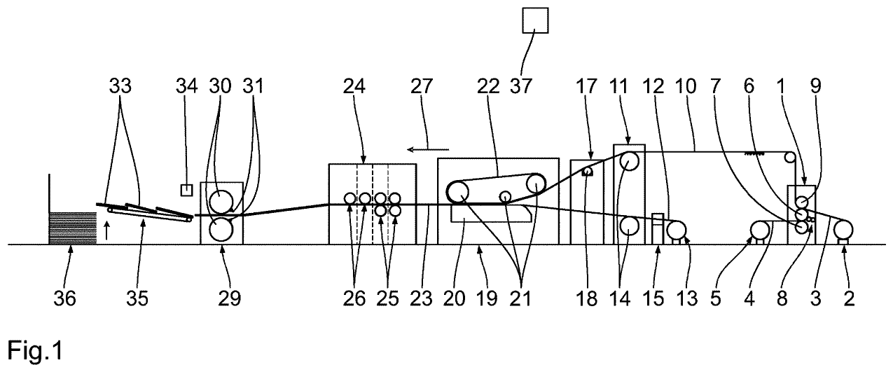

Referring first to FIG. 1, a corrugated cardboard plant comprises a device 1 for producing a corrugated cardboard web, which is laminated on one side.

A first unwinding device 2 feeds a first material web 3 to the device 1 for producing a corrugated cardboard web, which is laminated on one side. Advantageously, the first unwinding device 2 is designed as a splicing device so that the first material web 3 is endless.

In the device 1 for producing a corrugated cardboard web, which is laminated on one side, the first material web 3 is combined with a second material web 4, which comes from a second unwinding device 5. The second unwinding device 5 is preferably designed as a splicing device so that the second material web 4 is endless.

In the device 1 for producing a corrugated cardboard web, which is laminated on one side, the second material web 4 is guided between two adjacently arranged corrugating rollers 6, 7 so that the second material web 4 obtains a corrugation there. After passing through the corrugating rollers 6, 7 arranged in pairs, the second material web 4 is in the form of a corrugated web.

Subsequently, in the device 1 for producing a corrugated cardboard web, which is laminated on one side, glue is applied to the peaks of the corrugation of the second material web 4 by means of a gluing unit 8. The gluing unit 8 has a gluing roller, which forms a glue gap with the upper corrugating roller 6 and receives glue from a glue tank, directly or indirectly, preferably in a metered manner.

The second material web 4 provided with glue and the first material web 3 are then pressed together and connected to one another in the device 1 for producing a corrugated cardboard web, which is laminated on one side, in a press gap between a pressing unit 9 and the upper corrugating roller 6. The pressing unit 9 is designed, for example, as a pressing roller. Alternatively, it comprises, for example, at least two deflection rollers and a pressure belt guided around them.

A corrugated cardboard web 10, which is laminated on one side, which comprises the first material web 3 and the corrugated second material web or corrugated web 4, is guided out of the device 1 for producing a corrugated cardboard web, which is laminated on one side.

The corrugated cardboard web 10, which is laminated on one side, is fed to a preheating device 11.

Furthermore, a third material web 12 is fed from a third unwinding device 13 to the preheating device 11. The third unwinding device 13 is preferably designed as a splicing device so that the third material web 12 is endless. The third material web 12 forms an outer laminating web in the finished corrugated cardboard.

The preheating device 11 has two heatable heating rollers 14, which are arranged one above the other and extend in parallel with one another and horizontally. The corrugated cardboard web 10, which is laminated on one side, and the third material web 12 partially wrap around the particular heating roller 14 in the preheating device 11.

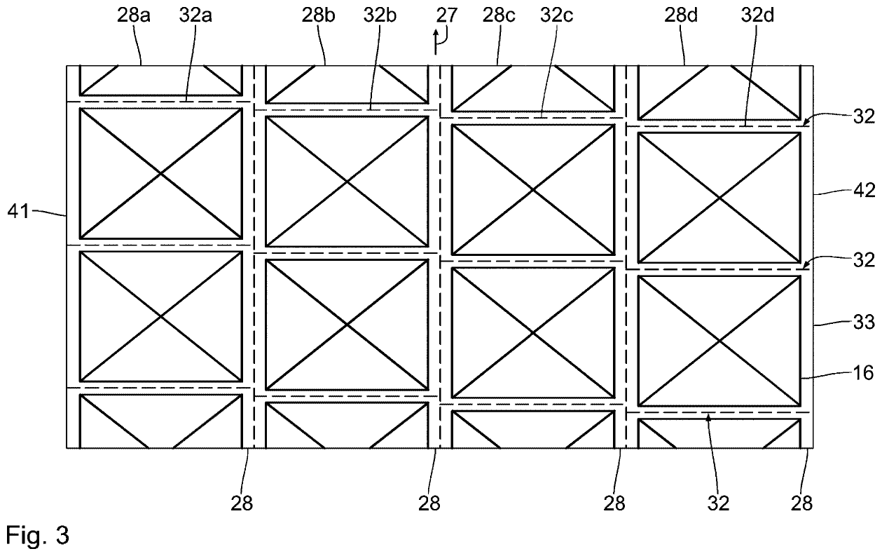

Between the third unwinding device 13 and the preheating device 11, a digital printing assembly 15 is arranged, which prints the third material web 12 on one printing side and is thus integrated in the corrugated cardboard plant. The printing side of the finished corrugated cardboard forms a free outer side and is thus visible. The digital printing assembly 15 has, for example, a central cylinder or printing cylinder and a printhead unit assigned thereto. It is capable of producing imprints 16 (cf. FIG. 3) on the printing side. Different positioning of the digital printing assembly 15 is alternatively possible. The corrugated cardboard plant and the digital printing assembly 15 form a system.

Arranged downstream of the preheating device 11 is a gluing station 17 with a glue application roller 18, which receives glue from a glue bath directly or indirectly, preferably in a metered manner. The peaks of the corrugation of the corrugated cardboard web 10, which is laminated on one side, are in contact with the glue application roller 18 so that they are provided with glue there.

Arranged downstream of the gluing station 17 is a heating and pressing device 19, which comprises a horizontal table 20 with heating plates. Above the table 20, the heating and pressing device 19 has a driven, endless pressing belt 22 guided around guide rollers 21. A pressing gap, through which the corrugated cardboard web 10, which is laminated on one side, and the third material web 12 are guided and pressed against one another there, is formed between the pressing belt 22 and the table 20. In the heating and pressing device 19, a three-layer corrugated cardboard web 23 is formed, which is laminated on both sides. The heating and pressing device 19 thus forms a device for producing a corrugated cardboard web, which is laminated on both sides.

Arranged downstream of the heating and pressing device 19 is a longitudinal cutting/creasing device 24, which comprises creasing units 25 and longitudinal cutting units 26. The creasing units 25 each have two tool beds, which are arranged substantially mirror-symmetrically with respect to the corrugated cardboard web 23, which is laminated on both sides. Creasing tools, which are arranged on tool carriers and can be moved individually transversely to a transport direction 27 of the corrugated cardboard, are provided on the pivotable tool beds and can be individually brought into engagement with the corrugated cardboard web 23, which is laminated on both sides.

The longitudinal cutting units 26 have tool beds, on which rotating blades are provided, which are arranged on tool carriers and can be moved individually transversely to the transport direction 27 of the corrugated cardboard. The blades can be individually brought into engagement with the corrugated cardboard web 23, which is laminated on both sides, and work together with rotationally driven brush rollers arranged on the other side of the corrugated cardboard web 23, which is laminated on both sides, when the blades are immersed in the corrugated cardboard web 23, which is laminated on both sides. The longitudinal cutting units 26 are capable of cutting the corrugated cardboard web 23, which is laminated on both sides, into corrugated cardboard part-webs 28, which extend and move in the transport direction 27 of the corrugated cardboard (FIG. 3).

Arranged downstream of the longitudinal cutting/creasing device 24 is a cross-cutting device 29, which comprises two rotationally drivable cross-cutting rollers 30, which are arranged one above the other in pairs and extend substantially perpendicularly to the transport direction 27 of the corrugated cardboard. Each cross-cutting roller 30 extends horizontally and carries a radially outwardly extending cross-cutting blade 31. The cross-cutting blades 31 work together to completely transversely sever the corrugated cardboard part-webs 28 guided through the cross-cutting rollers 30. In the corrugated cardboard part-webs 28, the rotationally driven cross-cutting rollers 30 thus produce cross-cuts 32 to form corrugated cardboard sheets 33 with corresponding lateral edges (FIG. 3). The cross-cutting rollers 30 cut all corrugated cardboard part-webs 28.

Arranged downstream of and adjacent to the cross-cutting device 29 is a cross-cut detection assembly 34, which is assigned to the corrugated cardboard part-webs 28 and is capable of detecting the cross-cuts 32. The cross-cut detection assembly 34 extends transversely to the transport direction 27 of the corrugated cardboard and across all corrugated cardboard part-webs 28 Arranged downstream of the cross-cutting device 29 is also a conveyor belt 35, on which the corrugated cardboard sheets 33 are guided to a stacking unit 36.

The corrugated cardboard plant also has a corrugated cardboard plant actuation assembly 37, which is designed as a corrugated cardboard plant control assembly and is capable of carrying out a corresponding control of the corrugated cardboard plant.

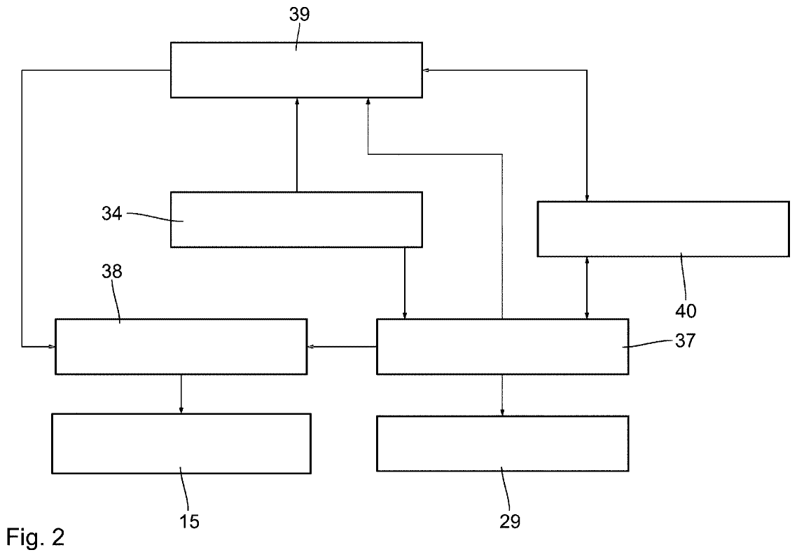

As FIG. 2 shows, the corrugated cardboard plant actuation assembly 37 is at least temporarily in signal connection with the cross-cutting device 29 and is capable of controlling it to cross-cut the corrugated cardboard part-webs 28. In particular, the cross-cutting rollers 30 can be rotationally driven accordingly.

In addition, the corrugated cardboard plant actuation assembly 37 is at least temporarily in signal connection with a printing assembly actuation unit 38, which is designed in particular as a printing assembly control unit. The printing assembly actuation unit 38 is part of the digital printing assembly 15 or is designed to be separate therefrom. The corrugated cardboard plant actuation assembly 37 is capable of transmitting corresponding control signals, which relate to the printing, in particular to print target points or print target locations, to the printing assembly actuation unit 38. The printing assembly actuation unit 38, in turn, is capable of controlling the printhead unit of the digital printing assembly 15 accordingly, which leads to a corresponding printing process.

The cross-cut detection assembly 34 is at least temporarily in signal connection with the corrugated cardboard plant actuation assembly 37 and is capable of transmitting position information of the produced cross-cuts 32 to the corrugated cardboard plant actuation assembly 37. The corrugated cardboard plant actuation assembly 37 evaluates target cross-cut positions and actual cross-cut positions. In particular, it compares them with one another.

If a recognized deviation between the target cross-cut positions and actual cross-cut positions is too large, the corrugated cardboard plant actuation assembly 37 controls the printing assembly actuation unit 38 in such a way that the deviation is reduced by changing the position(s) of the corresponding imprint(s) 16. The digital printing assembly 15 prints accordingly. The prepress stages or imprints 16 are prepared on the basis of pre-planned speed changes of the cross-cutting device 29. A corrugated cardboard plant speed forms a master or master information.

The cross-cut detection assembly 34 is also at least temporarily in signal connection with an experience database 39 and is capable of transmitting actual cross-cut (position) values or actual cross-cut (position) information or findings to the experience database 39 for subsequent identical orders or order combinations.

The corrugated cardboard plant actuation assembly 37 is also at least temporarily in signal connection with the experience database 39 and is capable of receiving corresponding actual values or findings, which relate, for example, to corresponding setting parameters or operating parameters of the corrugated cardboard plant.

The experience database 39 is at least temporarily in signal connection with the printing assembly actuation unit 38 and is, for example, capable of providing start parameters of the digital printing assembly 15 if earlier, identical experience values are already present or stored there.

The experience database 39 is always updated immediately and in a timely manner by the corrugated cardboard plant actuation assembly 37.

The experience database 39 is also at least temporarily in signal connection with the production control 40. The experience database 39 is capable of transmitting corresponding experience values to the production control 40.

Conversely, the production control 40 is capable of receiving corresponding actual values from the experience database 37.

As FIG. 3 shows, in the corrugated cardboard part-webs 28, the cross-cuts 32 are arranged offset from one another across the width thereof or perpendicularly to the transport direction 27 of the corrugated cardboard for each corrugated cardboard part-web 28. They are offset from one another in the transport direction 27 of the corrugated cardboard, i.e., along the corresponding corrugated cardboard part-web 28. The offset(s) of the particular cross-cut 32 produced by the cross-cutting device 29 is/are, for example, due to the fact that the cross-cutting rollers 30 are arranged, in particular slightly, obliquely to the transported, corrugated cardboard web 23, which is laminated on both sides, in order to generally compensate for a cutting offset by the rotating cross-cutting rollers 30. Since the cross-cutting blades 31 are curved around the cross-cutting rollers 30, a scissor cut is created. During the scissor cut, the cross-cutting blades 31 briefly clamp the corrugated cardboard web 23, which is laminated on both sides, or the corrugated cardboard part-web 28 at the current cut. The still uncut side is briefly pushed away from the target cutting position, which creates the offset across the width of the corrugated cardboard web 23, which is laminated on both sides,. As already explained, the offset(s) of the particular cross-cut 32 produced by the cross-cutting device 29 is/are also, for example, due to the fact that the corrugated cardboard part-webs 28 are pulled for their transport and their respective web tension changes, in particular abruptly, due to the successive cross-cutting of the corrugated cardboard part-webs 28. As FIG. 3 shows, each cross-cut 32 is designed in steps or stairs.

According to FIG. 3, the corrugated cardboard web 23, which is laminated on both sides, has two opposite longitudinal edges 41 and 42, which extend in parallel with one another and with the transport direction 27 of the corrugated cardboard.

In the first corrugated cardboard part-web 28a adjoining the first longitudinal edge 41 (FIG. 3, far left), each partial cross-cut 32a produced therein is ahead in comparison with each partial cross-cut 32b of the second corrugated cardboard part-web 28b arranged adjacent to the first corrugated cardboard part-web 28a.

In the second corrugated cardboard part-web 28b, each partial cross-cut 32b produced is ahead in comparison with each partial cross-cut 32c of the third corrugated cardboard part-web 28c arranged adjacent to the second corrugated cardboard part-web 28b.

In the third corrugated cardboard part-web 28c, each partial cross-cut 32c produced is ahead in comparison with each partial cross-cut 32d of the fourth corrugated cardboard part-web 28d, which is arranged adjacent to the third corrugated cardboard part-web 28c and includes the second longitudinal edge 42.

The partial cross-cuts 32a, b, c, d of each corrugated cardboard part-web 28a, b, c and d, respectively, run parallel to one another. The partial cross-cuts 32a, b, c, d produced by a cutting process each form a cross-cut 32 in the corrugated cardboard part-webs 28.

The corrugated cardboard part-webs 28 are separated from one another by longitudinal cuts 43, which are formed by the longitudinal cutting units 26. The longitudinal cuts 43 produced extend in the transport direction 27 of the corrugated cardboard and run parallel to one another. Longitudinal edges of the corrugated cardboard part-webs 28 are formed in this way. They run perpendicular to the partial cross-cuts 32a, b, c, d.

An embodiment without a cross-cut detection assembly 34 is, for example, alternatively possible. For example, corresponding findings may also come from the experience database 39, from historical data, expert knowledge, or the like.

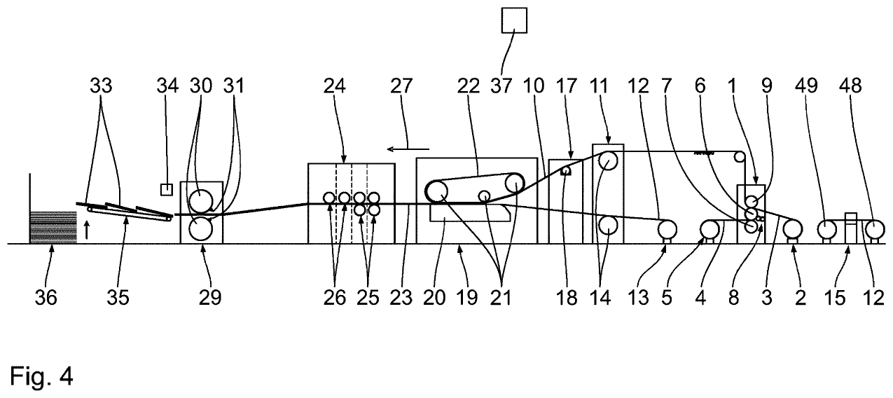

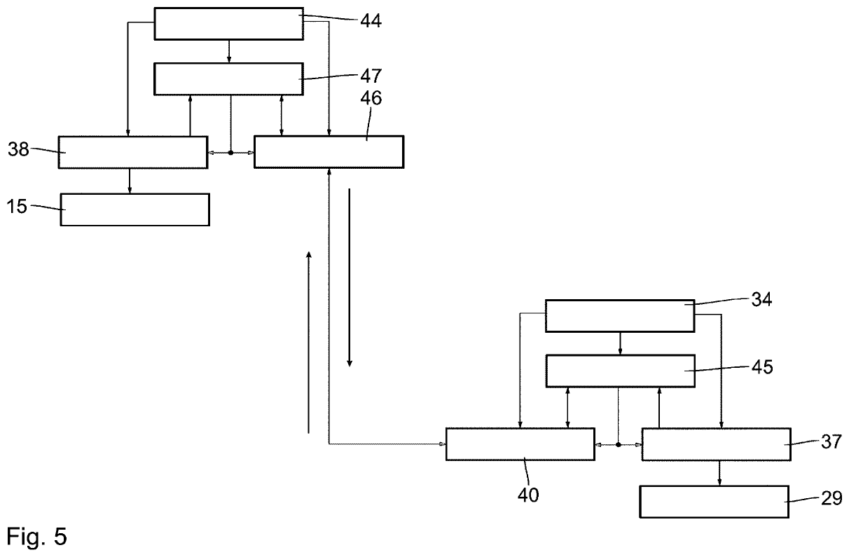

A second embodiment is described below with reference to FIGS. 4 and 5. Identical parts are given the same reference signs as in the previous embodiment, to whose description explicit reference is made.

According to this embodiment, the digital printing assembly 15 is arranged separately from the (actual) corrugated cardboard plant. Arranged upstream of the digital printing assembly 15 is an unwinding device 48, which is designed, for example, like the third unwinding device 13. In use, the unwinding device 48 unwinds a material web 12, which is guided through the digital printing assembly 15 for printing thereof.

Arranged downstream of the digital printing assembly 15 is a winding device 49, which comprises a rotatably mounted winding roll for winding up the, in particular printed, material web 12. The wound material web 12 can be transferred to the corrugated cardboard plant and used there as the third material web 12.

The cross-cut detection assembly 34 is here at least temporarily in signal connection with the production control 40 and the corrugated cardboard plant actuation assembly 37 as well as a corrugated cardboard plant experience database 45 and is capable of transmitting corresponding cross-cut information to them. The production control 40 serves to control the production of the corrugated cardboard plant and is capable of sending corresponding findings to the corrugated cardboard plant experience database 45 and corrugated cardboard plant actuation assembly 37 and to receive actual values from them.

The corrugated cardboard plant actuation unit 37 is again capable of controlling the cross-cutting device 29 accordingly. It is preferably also capable of evaluating the target and actual printing positions.

The production control 40 of the corrugated cardboard plant is at least temporarily in signal connection with a printing assembly production control 46. It is capable of transmitting production information of the corrugated cardboard plant to the printing assembly production control 46, which in turn is capable of receiving it. The production control 40 is capable of receiving corresponding printing information from the printing assembly production control 46. In particular, the production control 40 of the corrugated cardboard plant is capable of transmitting corrugated cardboard plant parameters, such as planned production speed, at least one cross-cutting device specification and/or a cutting accuracy for a particular job. Conversely, the printing assembly production control 46 is capable of receiving them. For example, it is capable of transmitting material web roll information, such as the positions of misprints, to the production control 40 of the corrugated cardboard plant. The production control 40 and the printing assembly production control 46 are preferably arranged at a spatial distance from one another. Bidirectional data or signal transmission is preferably possible between them.

The printing assembly production control 46 is at least temporarily in signal connection with the printing assembly actuation assembly 38 and is capable of supplying the printing assembly actuation unit 38 with corresponding information. It is also capable of receiving corresponding printing information from the printing assembly actuation assembly 38.

The printing assembly production control 46 also receives corresponding printing information from a printing assembly experience database 47 and the imprint position detection assembly 44.

An imprint detection assembly 44 also transmits print image information, for example whether the corresponding imprint 16 is complete or divided by cutting, to the printing assembly actuation unit 38 and the printing assembly experience database 47. The printing assembly actuation unit 38 controls the digital printing assembly 15 accordingly.

In this embodiment, in particular, a type of adaptation to individual properties of the cross-cutting device 29 is possible, for example to crucial properties, the course of the at least one cross-cutting blade, the environment and/or at least one auxiliary unit, such as a vacuum feed or the like.

Furthermore, adaptation to previously defined production parameters, such as corrugated cardboard plant speed, is possible.

Due to feedback from the printing assembly actuation unit 38 to the digital printing assembly 15, direct adjustment is possible. Optionally, if the amount of waste is too high, the corresponding corrugated cardboard sheets 33 can be directly reproduced. For this purpose, the corresponding material web(s) has/have an excess length.

Misprints are preferably marked digitally, which is transmitted directly to the production control 40 of the corrugated cardboard plant. Alternatively or additionally, indirect communication via intelligent codes on the corresponding material web is possible.

Specified production parameters can be read from the production control 40 of the corrugated cardboard plant. Possible misprints can also be read from the production control 40 of the corrugated cardboard plant, which allows for corresponding rejection. The corrugated cardboard plant actuation assembly 37 is again capable of evaluating or comparing target/actual cross-cut positions. Corresponding information can again be transmitted to the production control 40 of the corrugated cardboard plant.

Actual values and findings can be saved in the corrugated cardboard plant experience database 47. The actual cutting positions are fed back to the printing assembly experience database 47. The corrugated cardboard plant experience database 45 can be updated at any time and in a timely manner.

1. A printing assembly for printing imprints onto a corrugated cardboard web, which is laminated on both sides, and/or at least one material web for forming the corrugated cardboard web wherein the printing assembly is capable of
a) receiving printing data relating to the printing, and
b) adjusting at least one position of at least one of the imprints in a longitudinal direction of the web.

2. The printing assembly according to claim 1, wherein the printing assembly is capable of arranging imprints next to one another and, during transport in a transport direction of printing the imprints, which are arranged next to one another, offset from one another in and/or counter to the transport direction in order to adjust their position in the longitudinal direction of the web.

3. The printing assembly according to claim 1, wherein the printing assembly is capable of arranging imprints next to one another and of adjusting at least one position of at least one of the imprints which are arranged next to one another, depending on at least one adjacent cross-cut.

4. A system comprising:
a) a corrugated cardboard plant for producing corrugated cardboard, the corrugated cardboard plant comprising
i) at least one device for producing at least one corrugated cardboard web, which is laminated on one side,
ii) a device arranged downstream of the at least one device for producing at least one corrugated cardboard web, which is laminated on one side, in a transport direction of the corrugated cardboard, for producing the corrugated cardboard web, from at least one corrugated cardboard web which is laminated on one side, and a laminating web
iii) a longitudinal cutting device arranged downstream of the device for producing a corrugated cardboard web, which is laminated on both sides, in the transport direction of the corrugated cardboard, for longitudinally cutting the corrugated cardboard web which is laminated on both sides, into corrugated cardboard part-webs
iv) a cross-cutting device arranged downstream of the longitudinal cutting device in the transport direction of the corrugated cardboard, for cross-cutting the corrugated cardboard part-webs into corrugated cardboard sheets to produce cross-cuts and
v) a corrugated cardboard plant actuation assembly and
b) with at least one printing assembly according to claim 1 claims arranged upstream of the cross-cutting device

5. The system according to claim 4, further comprising a cross-cut detection assembly arranged downstream of the cross-cutting device in the transport direction of the corrugated cardboard, for detecting the cross-cuts produced by the cross-cutting device

6. The system according to claim 5, further comprising a cross-cut position evaluation unit, which is at least temporarily in signal connection with the cross-cut detection assembly for evaluating target cross-cut positions and actual cross-cut positions of the corrugated cardboard sheets.

7. The system according to claim 5, wherein the cross-cut detection assembly is capable of detecting cross-cutting marks for actuating the cross-cutting device.

8. The system according to claim 5, wherein the cross-cut detection assembly is capable of at least temporarily being in signal connection with the at least one printing assembly.

9. The system according to claim 4, by further comprising an experience database for saving actual corrugated cardboard production values for corresponding subsequent corrugated cardboard production orders.

10. The system according to claim 9, wherein the experience database is at least temporarily in signal connection with the corrugated cardboard plant actuation assembly.

11. The system according to claim 4, wherein the offset printing of the imprints can be adjusted depending on a corrugated cardboard transport speed.

12. The system according to claim 4, wherein the at least one printing assembly is capable of printing at least one imprint depending on the cross-cutting device in particular depending on a planned speed change of the cross-cutting device and/or at least one property of the cross-cutting device.

13. The system according to claim 4, wherein the at least one printing assembly is part of the corrugated cardboard plant or is arranged upstream thereof.

14. A printing method comprising the steps of
receiving printing data relating to printing a corrugated cardboard web which is laminated on both sides, and/or at least one material web for forming the corrugated cardboard web which is laminated on both sides,
printing, using the printing data, imprints onto the corrugated cardboard web, and/or at least one material web for forming the corrugated cardboard web, and
adjusting at least one position of at least one of the imprints in a longitudinal direction of the web.

15. A material web comprising imprints arranged next to one another in the width direction thereof, wherein the imprints arranged in a particular row are arranged offset from one another in and/or counter to a longitudinal direction of the material web.
